(19) United States
(12) Patent Application Publication
(10) Pub. No.: US 2002/0114163 A1
(43) Pub. Date: Aug. 22, 2002

(54) Lampshade structure having better light-penetrating effect

(76) Inventor: Chia-Teh Chen, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/789,609

(22) Filed: Feb. 22, 2001

(51) Int. Cl. F21V 1/00

(52) U.S. Cl. 362/351

(57) ABSTRACT

The present invention proposes a lampshade structure having better light-penetrating effect, which is a hollow mantle made of bone china and having an unrestricted look. A hollow part is provided therein for receiving a light bulb. An opening is provided at the lower end thereof. A plurality of light-penetrating holes are provided at the upper end thereof. An accidented surface is formed on the side wall thereof. Thereby, a lampshade structure having better light-penetrating effect can show variation of three-dimensional patterns by means of the accidented surface thereof.

### FIELD OF THE INVENTION

The present invention relates to a lampshade structure having better light-penetrating effect and, more particularly, to a lampshade structure capable of resisting high temperature, having better light-penetrating effect, and capable of showing effects of three-dimensional patterns or lines. Thereby, the aura of art can be greatly enhanced, and the valuation thereof can be effectively increased.

### BACKGROUND OF THE INVENTION

Along with the enhancement of level of lives, lightings and illuminations have been gradually appreciated. If proper illuminations are matched in the indoor decoration, both effects of practical use and delicacy can be obtained. In view of the potential market of lightings and illuminations, various kinds of new products, such as wall lamps, chandeliers, ceiling lamps, desk lamps, table lamps, floor lamps, or track lamps, have been researched and developed.

Most illuminations have lampshades covering outside to protect light bulbs therein and to enhance delicacy. Different variations of patterns can be formed on the lampshade to enhance the aura of art and to increase the valuation thereof.

As shown in FIG. 1, a prior art lampshade 10a is a hollow mantle made of paper, cloth, or plastic. A light bulb (not shown) is received therein. Because the lampshade 10a is made of paper, cloth, or plastic, it cannot resist high temperature and has no light-collecting effect so that contrastive effect of three-dimensional patterns or lines cannot be exhibited. Therefore, the aura of art cannot be enhanced, and the valuation thereof cannot be increased. Accordingly, the above prior art lampshade has inconvenience and drawbacks in practical use.

### SUMMARY OF THE INVENTION

The primary object of the present invention is to provide a lampshade structure having better light-penetrating effect and capable of resisting high temperature. When a light bulb therein is turned on, light can penetrate through the lampshade and be transmitted out. Different light-collecting effects can be generated through the accidented surface of the lampshade so as to show contrastive effects of brightness and darkness. Therefore, the aura of art can be greatly enhanced, and the valuation of the lampshade can be effectively increased.

To achieve the above object, the present invention provides a lampshade structure having better light-penetrating effect. The lampshade of the present invention is made of bone china, has a hollow part therein for receiving a light bulb, and has an accidented surface thereon.

The various objects and advantages of the present invention will be more readily understood from the following detailed description when read in conjunction with the appended drawings, in which:

### BRIEF DESCRIPTION OF THE DRAWINGS

FIG. 1 is a perspective view of a prior art lampshade;

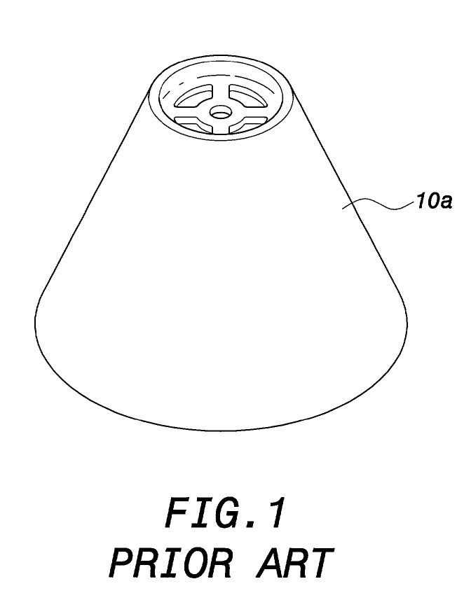

FIG. 2 is a perspective view of the present invention;

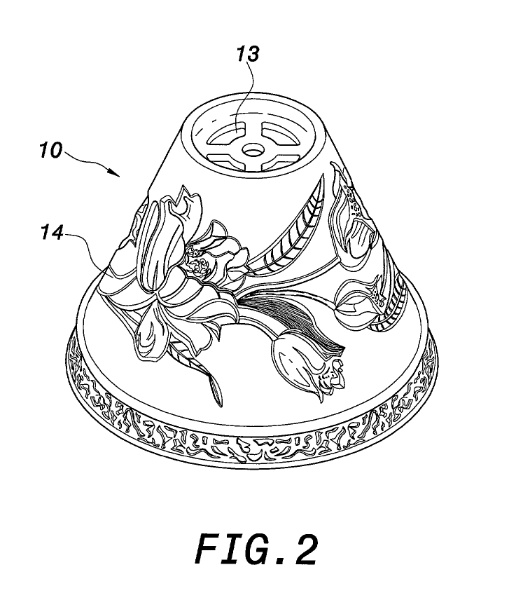

FIG. 3 is a cross-sectional view of the present invention;

FIG. 4 is a view showing the use state of the present invention; and

FIG. 5 is a manufacturing flowchart of the lampshade of the present invention.

### DETAILED DESCRIPTION OF THE PREFERRED EMBODIMENTS

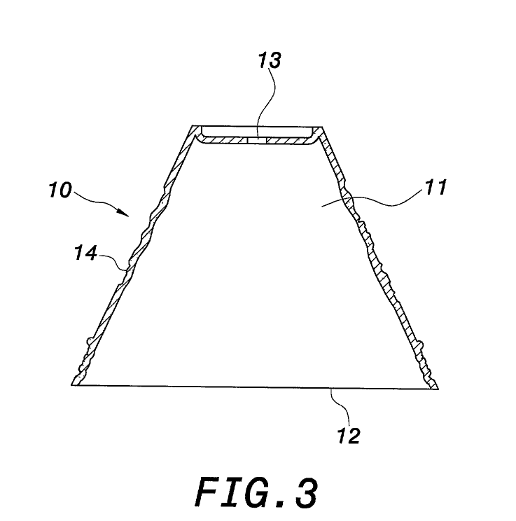

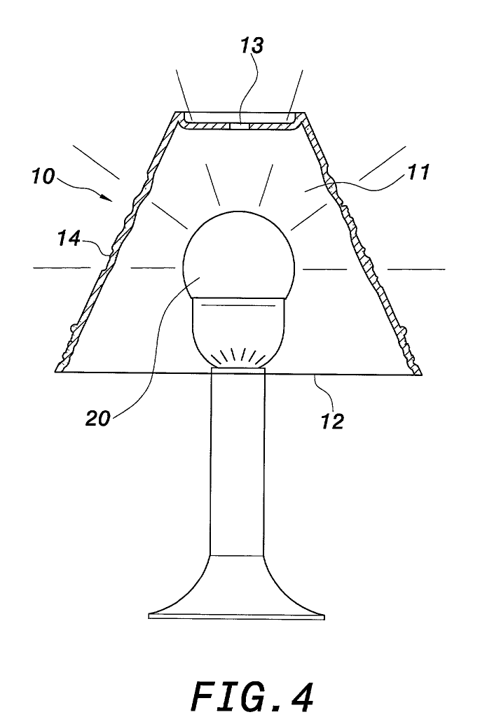

The present invention provides a lampshade having better light-penetrating effect. As shown in FIGS. 3 and 4, the lampshade 10 is a hollow mantle made of bone china. The material of china includes bone china, new bone china, full china, and pearl china. The lampshade of the present invention is made of bone china. Bone powder of animals (e.g., bone powder of cows comprising 35% tri-calcium phosphate) is added in during the manufacturing process of bone china to increase the hardness and the light-penetrating capability thereof.

The lampshade 10 has an unrestricted look, which can be varied according to necessity. This embodiment of the lampshade 10 is of cone shape and has a thinner thickness. A hollow part 11 is formed in the lampshade 10 for receiving a light bulb 20, as shown in FIG. 4. An opening 12 is provided at the lower end of the lampshade 10. A plurality of light-penetrating holes 13 is provided at the upper end of the lampshade 10 to form a supporting structure. An accidented surface is integrally formed on the side wall of the lampshade 10. Variation of three-dimensional patterns, such as figures, plants, animals, landscapes, or constructions, can be formed by means of the accidented surface. The pattern on the accidented surface of this embodiment is a plant pattern. Thereby, a lampshade having better light-penetrating effect is formed.

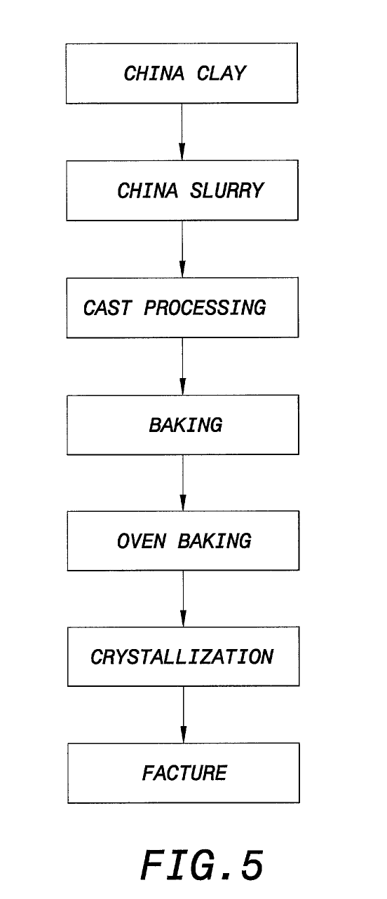

FIG. 5 shows a manufacturing flowchart of the lampshade of the present invention comprising the following steps:

(a). First, proper quantity of china clay (bone china) is provided as raw material.

(b). The china slurry is made by adding proper quantity of water into the china clay.

(c). The china slurry is filled into a cast.

(d). The china slurry is hardened to form a blank of specific shape by baking.

(e). The blank is placed into an oven to be baked and crystallize so as to form a facture of lampshade.

As shown in FIG. 4, the lampshade 10 can cover outside the light bulb 20 of an illumination. Because the bone china can resist high temperature and has better light-penetrating effect, light can penetrate through the lampshade 10 and be transmitted out when the light bulb 20 is turned on. Because the accidented surface 14 is formed on the lampshade 10, different light-collecting effects can be generated by means of the accidented surface 14 so as to show contrastive effects of three-dimensional patterns or lines. Therefore, brand-new feel of splendor and romance can be exhibited so that the aura of art can be greatly enhanced, and the valuation of the lampshade 10 can be effectively increased.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims. 4

I claim:

1. A lampshade structure having better light-penetrating effect, said lampshade being made of bone china, having a hollow part therein, and having an accidented surface thereon.

2. The lampshade structure having better light-penetrating effect as claimed in claim 1, wherein said lampshade has an opening at a lower end thereof and has a supporting structure at an upper end thereof.

3. The lampshade structure having better light-penetrating effect as claimed in claim 1, wherein said accidented surface is formed on a side wall of said lampshade.

4. The lampshade structure having better light-penetrating effect as claimed in claim 1, wherein variation of three-dimensional patterns is shown when light penetrates through said accidented surface.

5. The lampshade structure having better light-penetrating effect as claimed in claim 4, wherein the pattern of said accidented surface can be figures, plants, animals, landscapes, or constructions.
